(19) United States
(12) Patent Application Publication
(10) Pub. No.: US 2004/0003628 A1
(43) Pub. Date: Jan. 8, 2004

(54) Optical fiber manufacturing method and apparatus

(76) Inventors: Takayuki Shimazu, Kanagawa (JP); Katsuya Nagayama, Kanagawa (JP); Shigeyuki Tanaka, Kanagawa (JP)

Correspondence Address: MCDERMOTT, WILL & EMERY, 600 13th Street, N.W., Washington, DC, 20005-3096, US

(21) Appl. No.: 10/403,511

(22) Filed: Apr. 1, 2003

(30) Foreign Application Priority Data
Apr. 1, 2002 (JP) 2002-099143

(51) Int. Cl. C03B 37/022; C03B 37/075

(52) U.S. Cl. 65/402; 65/504

(57) ABSTRACT

An optical fiber manufacturing method and apparatus in which an optical fiber is drawn from an optical fiber preform, while rotating the optical fiber, to impart the optical fiber with twist. Specifically, with the optical fiber in contact with an arc concave surface of first swing guide roller under a predetermined force, a first swing guide roller is swung with the center of the arc concave surface to twist the optical fiber. In this arrangement, the variation range of the path of the optical fiber can be reduced, making it possible to stabilize the pressure of the swing guide roller against the optical fiber. Accordingly, the frictional force developed across the swing guide roller and the optical fiber can be kept constant to make slippage less likely, making it possible to efficiently twist the optical fiber always at a predetermined rotatory force.

### BACKGROUND OF THE INVENTION

1. Field of the Invention

The present invention relates to an optical fiber manufacturing method and apparatus. More particularly, the invention relates to an optical fiber manufacturing method and apparatus to impart a twist in the optical fiber.

2. Description of the Related Art

In a related art optical fiber manufacturing method, one end of an optical fiber preform is softened by heating and the optical fiber is drawn from the optical fiber preform. However, with this manufacturing method, it is difficult making a core portion of the optical fiber and a cladding portion around the core potion perfectly circular in cross section. That is, the cross-sections of both the core portion and the cladding portion around the core portion usually become slightly elliptic or slightly distorted from a circular shape.

Accordingly, the refractive index distribution in the cross-section is not completely uniform, which increases a difference in group velocities of two orthogonally polarized waves in the section of the optical fiber, thereby increasing polarization mode dispersion. For this reason, an optical fiber manufacturing method is proposed in U.S. Pat. No. 6,076,376.

As shown in FIG. 6, an optical fiber 101 rolls on a roller surface 103 of the guide roller 100 so that a swing motion of the guide roller 100 is such that the maximum clockwise (θ) angle and the maximum counter clockwise angle (−θ) are equal. The swing direction of the guide roller 100 is smoothly reversed when the swing angle of the guide roller 100 is maximum.

While the optical fiber 101 rolls on the roller surface 103 of the guide roller 100, the optical fiber is fitted on V-shaped groove 103 of a guide roller 102, which is horizontally set beside the guide roller 100, thereby preventing the optical fiber from swinging. Accordingly, a twist can be imparted to the optical fiber 101.

However, one draw-back or problem with the optical fiber manufacturing method shown in FIG. 6, is that the apparatus which is used to impart the twist to the optical fiber 101 is large-scale, since the guide rollers 100, 102 form part of the apparatus.

The optical fiber is twisted by a force which is produced by swing motion of the guide rollers and which works to move the optical fiber from its path. The twist of the optical fiber 101 varies depending on a tension of the optical fiber 101. Accordingly, it is difficult to impart a constant twist to the optical fiber 101.

Further, friction between the optical fiber 101 and the guide roller 100 is changed depending on the type of resin coated on the optical fiber 101. Accordingly, a constant twist cannot be efficiently imparted to the optical fiber 101.

### SUMMARY OF THE INVENTION

It is one object of the invention to provide an optical fiber manufacturing method and apparatus in which a twist is efficiently imparted to an optical fiber so that the optical fiber has a small polarization mode dispersion.

In order to accomplish the aforementioned object, one embodiment of the method for manufacturing an optical fiber according to the invention comprises drawing an optical fiber from an optical fiber preform, wherein with optical fiber in contact with an arc concave roller surface of a first swing guide roller, the first swing guider roller is swung around the center of the arc concave roller surface as a swing center to twist the optical fiber.

The apparatus for the manufacture of an optical fiber according to one embodiment of the invention has a twisting mechanism for drawing an optical fiber from an optical fiber preform while rotating the optical fiber to provide the optical fiber with twist, wherein the twisting mechanism comprises a first swing guider roller having an arc concave roller surface with which the optical fiber comes into contact, which can be swung around the center of the arc concave surface as a swing center.

In accordance with the method and apparatus for the manufacture of an optical fiber having the aforementioned constitution, the optical fiber does not get away from the path thereof, making it possible to stabilize the pressure to be applied to the optical fiber by the swing guide roller. Accordingly, the frictional force developed between the swing guide roller and the optical fiber can be kept constant to make slippage less likely. Thus, the optical fiber can be always twisted efficiently with a predetermined rotary force. The method and apparatus for the manufacture of an optical fiber of the invention overcomes the problems associated with the related art wherein the frictional force between the optical fiber and the roller surface changes depending on tension of the optical fiber, affecting twist efficiency.

It is preferable that the radius of curvature of the arc concave roller surface of the first swing guide roller be large so that the optical fiber less gets away from the path thereof when the first swing guide roller swings. The radius of curvature of the roller surface is preferably not smaller than about 100 mm. Further, in order to allow the optical fiber to roll over the roller surface without slippage, the surface roughness of the roller surface is preferably not smaller than about 5 μm.

The method for the manufacture of an optical fiber according to the invention is such that the optical fiber is interposed under a predetermined force between the roller surface of the first swing guide roller and the roller surface of a second swing guide roller having an arc convex roller surface, the center of which is swing center of the first swing guide roller, and wherein the first swing guide roller and/or the second swing guide roller swing to twist the optical fiber.

The method for the manufacture of an optical fiber according to the invention may further include a twisting mechanism comprising a second swing guide roller having an arc convex roller surface disposed at a predetermined distance from the arc concave roller surface of the first swing guide roller. The swing of the second swing roller coincides with the swing center of the first swing roller.

In accordance with the method and apparatus for the manufacture of an optical fiber having the aforementioned constitution, the roller surface of the first swing guide roller and the roller surface of the second swing guide roller are concentric with each other at the swing center in a section extending through the rolling center of rotation of the two rollers. In this arrangement, the optical fiber interposed between the roller surface of the two swing guide rollers under a predetermined pressure is rotated and twisted, providing assurance that the optical fiber is twisted.

When the force under which the optical fiber is interposed between the two roller surfaces is too high, the optical fiber can be damaged or the drawing conditions can be changed. Thus, the predetermined force is preferably adjusted to not greater than about 1.0 N as calculated in terms of force by which the optical fiber is clamped.

The method for the manufacture of an optical fiber according to the invention may further include synchronously the first swing guide roller and the second swing guide roller swing with each other in opposing directions.

In accordance with the method for the manufacture of an optical fiber having the aforementioned constitution, the swing angle of the second swing guide roller in the direction opposite that of the first swing guide roller is established as a parameter to prevent the optical fiber from sliding on the roller surface.

The method for the manufacture of an optical fiber according to the invention further may include varying the swing angle of the first swing guide roller.

In addition, or as an alternative to varying the swing angle, the swing speed of the first swing guide roller may be varied.

In accordance with the method for the manufacture of an optical fiber having the aforementioned constitution, the swing angle and/or swing speed of the first swing guide roller is varied to provide the optical fiber with random twist, making it possible to reduce the polarization mode dispersion.

The apparatus for the production of an optical fiber may include a roller surface of at least one of the first swing guide roller and the second swing guide roller made of a rubber.

The term “roller surface made of a rubber” as used herein is meant to indicate that the roller may be entirely made of a rubber content or may be coated with a rubber only on the roller surface or portion thereof.

In accordance with the apparatus for the manufacture of an optical fiber having the aforementioned constitution, the optical fiber can be prevented from being damaged when clamped between the swing guide rollers. Further, the frictional force developed between the roller surface and the optical fiber can be enhanced to ensure that the optical fiber is rotated and twisted.

### BRIEF DESCRIPTION OF THE DRAWINGS

FIG. 1 is a perspective view showing an optical fiber manufacturing method according to the invention;

FIG. 2A is a sectional view showing the relationship between the positions of first and second swing guide rollers and the position of the optical fiber when the first and second swing guide rollers are arranged to interpose the optical fiber in the center of their surfaces;

FIG. 2B is a sectional view showing the aforementioned relationship when first swing guide roller is swung in a counterclockwise direction;

FIG. 2C is a sectional view showing the aforementioned relationship when the first swing guide roller is swung in a clockwise direction;

FIG. 3 is a diagram showing a part of the optical fiber manufacturing apparatus used for the first swing guide roller and second swing guide roller according to the invention;

FIG. 4 is a diagram showing a part of the optical fiber manufacturing apparatus provided with the first swing guide roller according to the invention;

FIG. 5A is a sectional view showing the swing motion of the optical fiber by first and second swing guide rollers according to the invention;

FIG. 5B is a sectional view showing the swing motion of the optical fiber by a related art swing guide roller;

FIG. 5C is a sectional view showing the swing motion of the optical fiber by use of the first swing guide roller according to the invention;

FIG. 6 is a diagram showing a twisting mechanism in a related art optical fiber manufacturing apparatus and method; and

FIGS. 7A and 7B are plans showing shape of surface of the swing guide roller.

### DETAILED DESCRIPTION OF THE INVENTION

Embodiments of the invention will be described in detail with reference to the attached drawings.

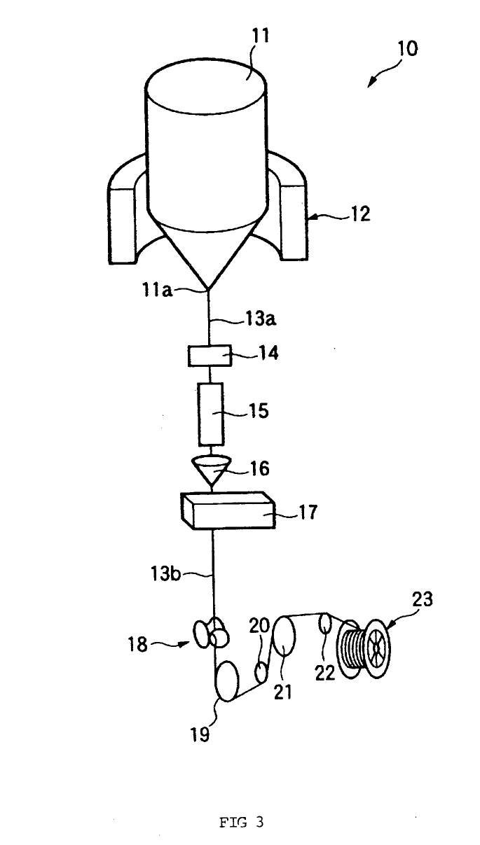

An optical fiber manufacturing apparatus 10 according to the invention is shown in FIG. 3. The optical fiber preform may be formed by a VAD method (vapor phase axial deposition), OVD method (external deposition), MCVD method (internal deposition), rod-in-tube method, or the like. As shown in FIG. 3, the optical fiber preform is fed into a drawing furnace to be softened and by heating in the drawing furnace. From this, the optical fiber 13a is drawn.

The outer diameter of the drawn optical fiber 13a is measured by an outer diameter measuring device 14. These measurements may then be fed back to control a temperature of the heater 12 and/or the drawing speed so that a predetermined outer diameter can be obtained.

The optical fiber 13a is cooled by a cooling device 15 and also passed through a resin coating unit 16 to be coated with an ultraviolet-curing liquid resin. Then, the optical fiber 13a is sequentially passed through a resin curing unit 17 that cures the coat by emission of ultraviolet rays.

The optical fiber 13b having a resin coat formed thereon is then rotated by a fiber twisting unit 18 to twist the optical fiber preform melting portion 11a inside the drawing furnace. The optical fiber 13b thus rotated is guided by a guide roller 19 provided below the fiber twisting unit 18, and then wound around a take-up machine 23 via guide rollers 20 and 22.

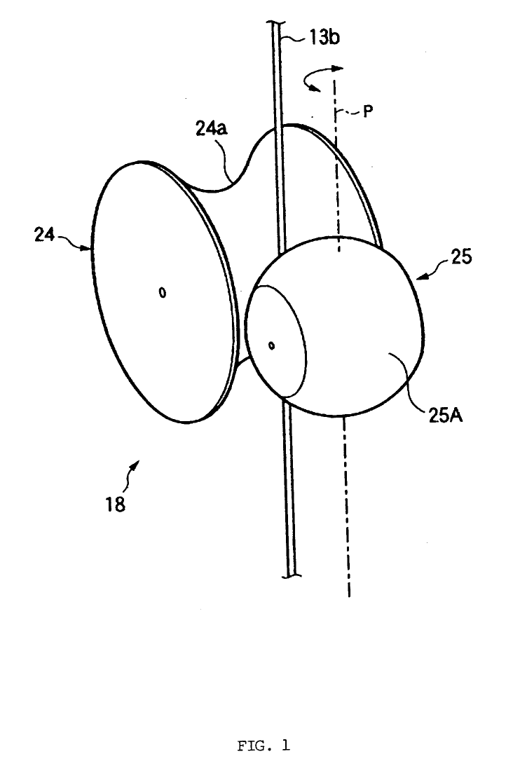

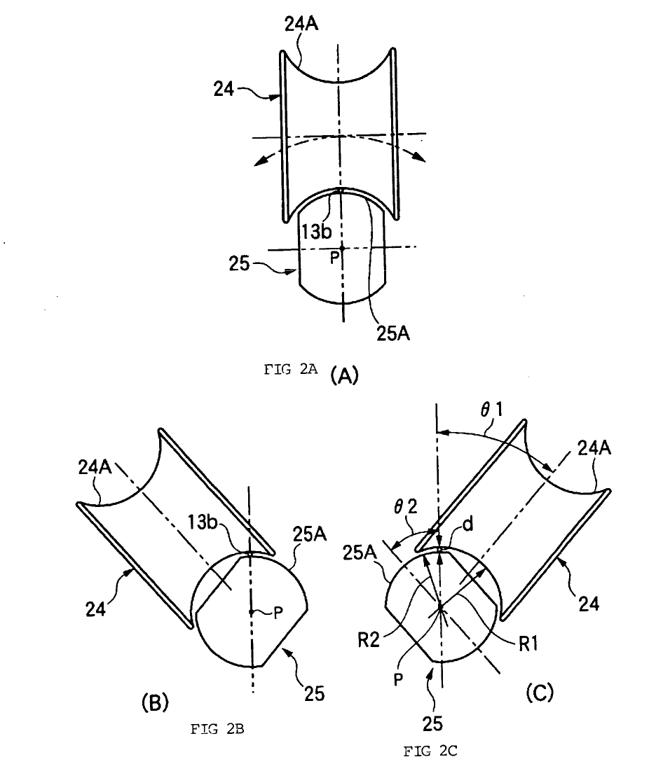

The fiber twisting unit 18 will be further described hereinafter with reference to FIGS. 1 and 2A-2C.

As shown in FIGS. 1 and 2A, the optical fiber twisting unit 18 comprises a first swing guide roller 24 having an arc concave roller surface 24A with which the optical fiber 13b comes in contact under a predetermined force. FIG. 2A is a cross-sectional view which shows a section including both rolling axes of the first roller and the second roller. In FIG. 2A, the first swing guide roller 24 swings around a center of the arc concave surface which coincides with a swing center P. As one configuration, the first swing guide roller 24 may be formed in a hand-drum shaped as shown. FIG. 2A shows a plane including a rolling axis L of the first swing guide roller and a contact point at which the first swing guide rollers comes into contact with the optical fiber. In FIG. 2A, the center as the swing center P is a center axis defined by both a center of the arc concave surface of the first swing guide roller 24A.

A second swing guide roller 25 has an arc convex roller surface 25A and is disposed at a predetermined distance from the arc concave surface 24A of the first swing guide roller 24. The second swing guide roller 25 swings around the swing center P. In FIGS. 2A-2C, both surface 24A of the first swing guide roller 24 and surface 25A of the second swing guide roller 25 are concentric with each other with the swing center P. The second swing guide roller 25 may be formed in such a shape as that of a sphere cut by two parallel planes. In FIG. 2A, the center of the second swing roller also coincides with the swing center P.

In order that the optical fiber less gets away from the path thereof when the first swing roller swings, it is preferable that the swing guide roller surface 24A have a large radius of curvature. Thus, the radius of curvature of the surface 24A is preferably not smaller than about 100 mm. Further, a surface roughness of the swing guide roller is preferably not smaller than about 5 μm so that the optical fiber 13b rolls over the surface 24A without slipping thereon.

If the optical fiber 13b is interposed between the two surfaces 24A, 25A with too high of a force, the optical fiber 13b may be damaged or drawing conditions may be changed. Thus, the optical fiber 13b is clamped with a predetermined force, which may be adjusted to not greater than about 1.0 N as calculated in terms of force Moreover, at least one or both the surface 24a of the swing guide roller 24 and the surface 25A of the swing guide roller 25 may made of, or coated partially or in full, with rubber so that the optical fiber 13b is not damaged when clamped between the swing guide rollers. The swing guide rollers 24, 25 may also be made entirely of rubber.

A motor is used to swing the first swing guide roller 24 and the second swing guide roller 25 in opposing directions with each other. For example, the first swing guide roller 24 and the second swing guide roller 25 can be equipped with a motor so that first and second swing rollers 24, 25 are swung synchronously in opposing directions with each other.

Alternatively, one motor may be used with a gear unit so that the first swing guide roller 24 and the second swing guide roller 25 are swung synchronously in opposing directions with each other. Further, a swing mechanism applied to a swing guide roller disclosed in U.S. Pat. No. 6,076,376 may be applied to the mechanism of the invention.

The operation of the twisting unit 18 will be described with reference to FIGS. 2A to 2C.

The optical fiber 13b is interposed between the surface 24A of the first swing guide roller 24 and the surface 25A of the second swing guide roller 25 under a predetermined force as shown in FIG. 2A,

The first swing guide roller 24 swings around the swing center P as shown in FIGS. 2B and 2C. At the same time, the second swing guide roller 25 swings around the swing center P in synchronizing with the first swing guide roller 24 in the direction opposite the first swing guide roller 24.

As shown in FIG. 2C, the first swing guide roller 24 is swung at an angle of θ1 while the second swing guide roller 25 is swung in the opposite direction at an angle of θ2. The radius of curvature of the surface 24A of the first swing guide roller 24 is R1. The radius of curvature of the swing guide roller surface 25A of the second swing guide roller 25 is R2. The diameter of the optical fiber 13b to be rotated is d. The swing angle of the first swing guide roller 24 is θ1. The swing angle of the second swing guide roller 25 is θ2. From this configuration, the following equations can be established:

R1R2+d

θ1=(R2/(R2+d))×θ2

In this arrangement, the optical fiber 13b interposed between the swing guide rollers 24, 25 is rotated. The optical fiber can remain at the path of the optical fiber because both surfaces 24A and 25B of the swing guide rollers 24, 25, respectively are swung synchronously in opposing directions.

An example of the twisting unit 18 will be described. In one embodiment, the twisting unit 18 was designed with d of 0.245 mm, R1 of 100.245 mm, R2 of 100 mm, θ1 of 9.976° and θ2 of 10°.

The drawing rate of the optical fiber 13b was then set to 100 m/min. The rotation frequency of both the first and second swing guide rollers 24, 25, was 10 rpm. The force applied to the optical fiber 13b was not greater than about 1.0 N. The surface roughness of both first and second swing guide rollers 24, 25 was not smaller than about 5 μm. The roughness of the swing guide roller surface was smaller than the outer diameter of the optical fiber. The optical fiber 13b was drawn while the first and second swing guide rollers are swung in opposing directions.

As a result of this set-up, the optical fiber 13b was rotated at a rate of 90.7 times/min. The number of twists per unit length was 0.907 turns/m.

The apparatus 10 according to the invention is not limited to the aforementioned embodiments. Proper modifications and improvements may be made in the apparatus 10 according to the teachings of this specification.

In the above-described embodiments, both the two swing guide rollers 24, 25 are swung. However, only one of the two swing guide rollers may be swung.

In case where swing guide roller 24 is provided without the swing guide roller 25, the surface 24A of the first swing guide roller 24 forms an arc concave surface so that the optical fiber 13 can be securely rotated to be twisted without slipping.

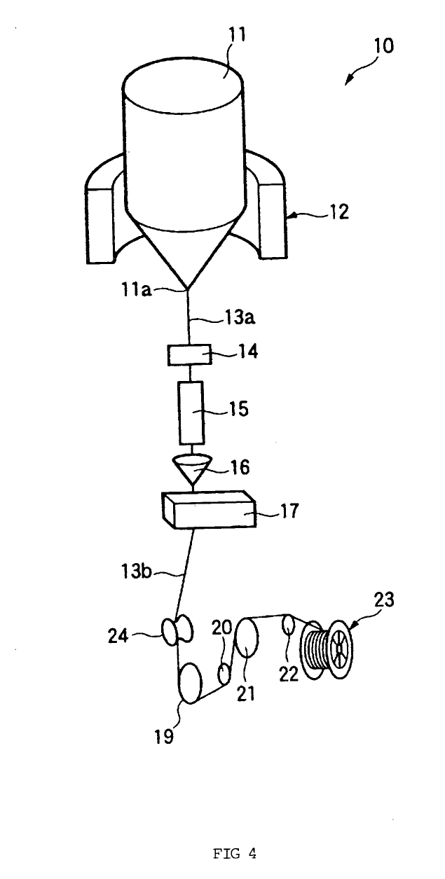

In the case where only the first swing guide roller 24 is provided, the first swing guide roller 24 contacts with the optical fiber 13b under a predetermined force resulting that the path of optical fiber may not be linear as shown in FIG. 4.

The twisting unit 18 may be provided at a position where the path of the optical fiber changes (the position of V roller shown in FIG. 3). In this case, a V roller is not needed.

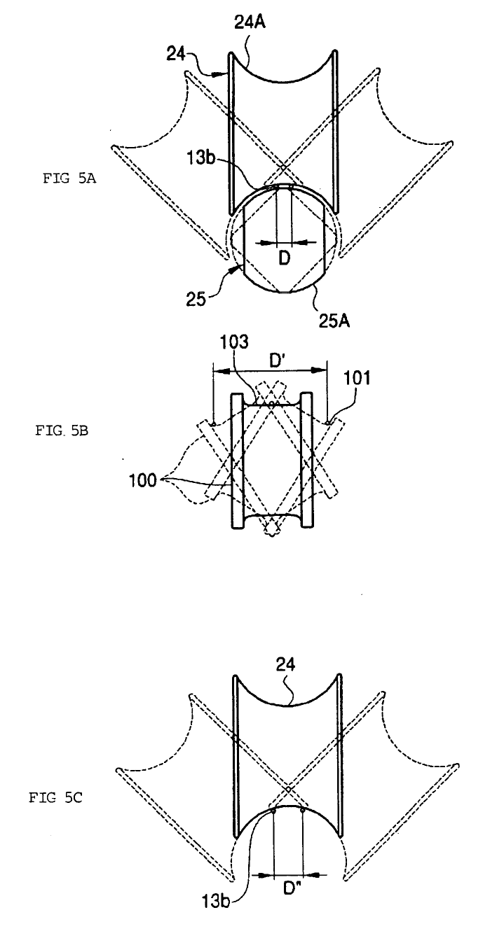

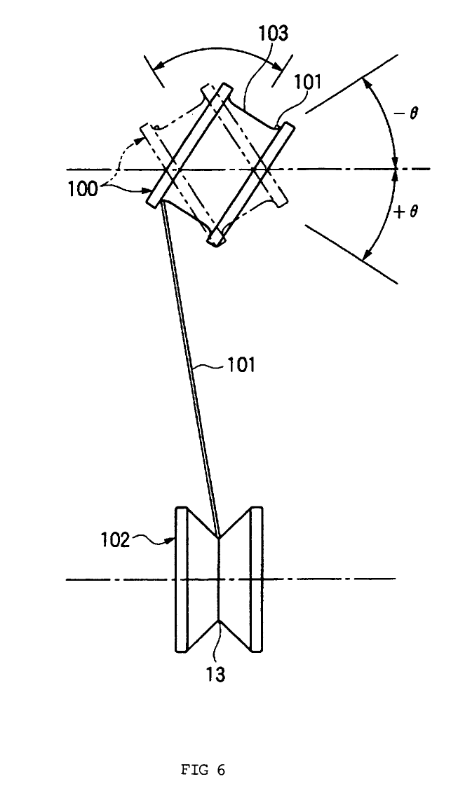

By swinging either or both of a first swing guide roller 24 having an arc concave surface 24A and a second swing guide roller 25 having an arc convex surface 25A with the optical fiber 13b interposed therebetween as shown in FIG. 5A, the variation range D of the path of the optical fiber can be reduced, and thereby the force applied to the optical fiber 13b can be made stable. Hereinafter, the variation range D means a range that the optical fiber gets away from the path of the optical fiber when the first swing guide roller is swung.

It has heretofore been practiced to rotate an optical fiber 101 over a swing guide roller 100 having a flat surface 103 as shown in FIG. 5B. Therefore, the variation range D′ of the optical fiber 101 due to the swing of the swing guide roller 100 changes drastically, causing change force provided by the surface 103 against the optical fiber 101. As the pressure of the rolling surface 103 against the optical fiber 101 decreases, the frictional force developed across the rolling surface 103 and the optical fiber 101 decreases, occasionally causing the optical fiber 101 to slip without rolling. In the arrangement shown in FIG. 5A, the frictional force developed across the optical fiber 13b and the first and second swing guide rollers can be kept substantially constant, making it possible to prevent the optical fiber from sliding on the first and second swing guide rollers 24, 25.

Also in the case where only one first swing guide roller 24 having an arc concave surface is used as shown in FIG. 5C, the variation range D′ of the optical fiber 13b can be reduced as compared with the case of FIG. 5B, and thereby the frictional force developed across the first swing guide roller 24 and the optical fiber 13b is stabilized. Accordingly, the optical fiber 13b rolls on the swing guide roller surface without slippage.

While the aforementioned embodiments have been described with reference to the case where the swing angle of the swing guide rollers 24, 25 are kept constant, the swing angle may be varied. In this case, the number of twists per unit length of optical fiber can be varied. By varying the swing angle at random, the optical fiber 13b can be provided with a random twist, making it possible to reduce the polarization mode dispersion.

Further, the speed of rotation of the swing guide roller 24 and/or 25 in the feeding direction of the optical fiber 13b can be varied. A swing angular velocity of the swing guide roller 24 and/or 25 may be varied. In this case, the optical fiber 13b is provided with a random twist, and thereby the polarization mode dispersion can be reduced.

When the concavity and/or convexity are on the surface of the swing guide roller, such as a case that an arithmetic means surface roughness Ra of a roller which represents surface characteristic is smaller than about 2% and not greater than about 12.5% of the outer diameter of the optical fiber thus produced, and a width of the concavity is smaller than about 2% and greater than about 40% ofthe outer diameter of the optical fiber thus produced, the optical fiber can be easily caught for an instant by the convexities portion of the surface to rotate on the surface of the swing guide roller. The arithmetic means surface roughness Ra may be defined according to JISB0601:2001.

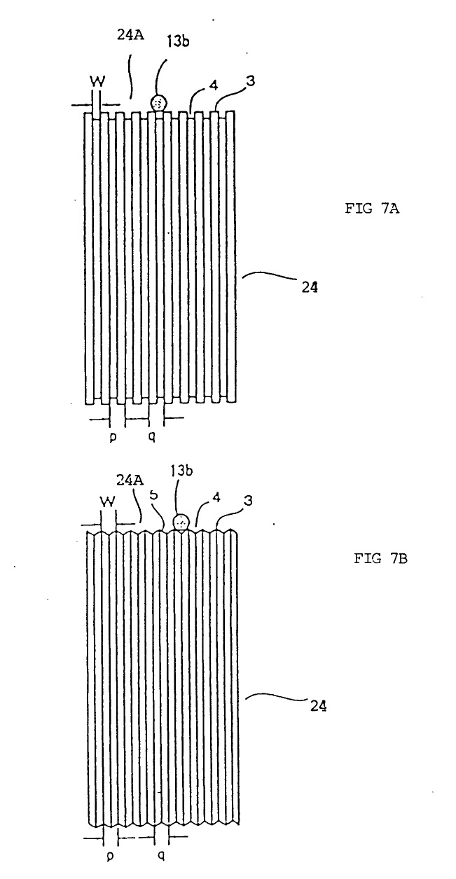

In the invention, the swing guide roller surface 24A of the swing guide roller 24 may be also provided with an unevenness as shown in FIG. 7A and 7B the unevenness may be applied to the swing guide roller surface 25A of the swing guide roller 25.

When Ra falls below about 5% of the outer diameter of the optical fiber 13a, the optical fiber slips with the swing guide roller surface and thus twisting efficiency becomes compromised. When Ra exceeds about 12.5% (one eighth) of the outer diameter of the optical fiber, the optical fiber falls into the concavity of the surface and thus cannot roll over the swing guide roller surface. When the width W of the concavity falls below about 5% of the outer diameter of the optical fiber, the optical fiber is less twisted. When the width W of the valley exceeds about 40% of the outer diameter of the optical fiber, the proportion of the valley in the swing guide roller surface is reduced, providing the optical fiber with less twist.

The convexity 3 of the surface may be in the form of rectangular shape as shown in FIG. 7A or in the form of triangular shape as shown in FIG. 7B. In the case where the convexity 3 is in the form of triangular shape, it is preferred that the arithmetic means surface roughness Ra of the inclined plane 5 of the unevenness be not smaller than about 2 μm and not greater than about 12.5% of the outer diameter of the optical fiber to be rotated, making it possible to prevent the optical fiber from sliding over the inclined plane.

When the swing guide roller 24 is swung, a force is applied to the optical fiber 13b to allow the optical fiber 13b to move along the swing guide roller surface 24A as previously mentioned. During this procedure, the optical fiber 13b moves beyond the convexity 3 but is caught for an instant by the convexity 3, assuring that the optical fiber 13b rolls.

The pitch p of the concavity 4 or the pitch q of the convexity 3 may not be constant but are preferably not smaller than about 5% and not greater than about 40% of the outer diameter of the optical fiber 13b to assure that the optical fiber 13b rolls.

As mentioned above, in accordance with the process and apparatus for the production of an optical fiber according to the invention, the swing guide roller surface of the first swing guide roller in the twisting mechanism forms an arc concave surface. In this arrangement, the frictional force developed across the swing guide roller surface and the optical fiber can be kept constant to make slippage less likely, making it possible to efficiently twist the optical fiber always at a predetermined rotatory force merely by a simple twisting mechanism.

What is claimed is:

1. An optical fiber manufacturing method, comprising:
drawing an optical fiber from an optical fiber preform;
swinging one or more swing guide rollers in such a manner that an arc concave surface of a first swing guide roller comes into contact with said optical fiber, wherein said first swing guide roller is swung around a center of said arc concave surface of said first swing guide roller as a swing center; and
imparting a twist to said optical fiber by said swinging.

2. The optical fiber manufacturing method according to claim 1, further comprising:
swinging at least one of the first swing guide roller and a second swing guide roller around the center of the concave surface of said first swing guide roller in such a manner that said optical fiber is interposed between said arc concave surface of said first swing roller guide and an arc convex surface of said second swing roller guide.

3. The optical fiber manufacturing method according to claim 2, wherein said first swing guide roller and said second swing guide roller are synchronously swung in opposing directions with each other.

4. The optical fiber manufacturing method according to claim 1, wherein the optical fiber is provided with a random twist.

5. The optical fiber manufacturing method according to claim 2, wherein the optical fiber is provided with a random twist.

6. The optical fiber manufacturing method according to claim 4, wherein a swing speed, a rotation speed, or a swing angular velocity of said first swing guide roller are varied.

7. The optical fiber manufacturing method according to claim 5, wherein a swing speed, a rotation speed, or a swing angular velocity of said first swing guide roller are varied.

8. An optical fiber manufacturing apparatus, comprising:
an optical fiber twist mechanism including a first swing guide roller having an arc concave surface, and
wherein said first swing guide roller is operable to swing around a center of said arc cave surface.

9. An optical fiber manufacturing apparatus, comprising:
an optical fiber twist mechanism including a first swing guide roller having an arc convex surface and first swing guide roller and/or second swing guide roller swings around the center of said arc concave surface of said first swing guide roller in such a manner that said optical fiber is interposed between said arc concave surface of said firs swing roller guide and an arc convex surface of said second swing guide roller.

10. The optical fiber manufacturing apparatus according to claim 9, wherein at least one of said first swing guide roller and said second swing guide roller includes a rubber content.

11. The optical fiber manufacturing apparatus according to claim 10, wherein the swing guide roller surface of at least one of said first swing guide roller and said second swing guide roller has a concavity and a convexity.

12. The optical fiber manufacturing apparatus according to claim 11, wherein an arithmetic means roughness of said swing guide roller surface is not smaller than about 2% and not greater than about 12.5% of an outer diameter of the optical fiber, and wherein a width of the concavity is not smaller than about 2% and not greater than about 40% of said outer diameter of said optical fiber.

13. An optical fiber manufacturing method, comprising:
drawing an optical fiber from an optical fiber preform;
swinging one or more swing guide rollers in such a manner that an arc concave surface of a first of said swing guide rollers comes into contact with said optical fiber, wherein said first swing guide roller is swung around a center axis, defined by both a center of the arc concave surface of the first swing guide roller on a plane, including both rolling axis of said first swing guide roller and a contact point at which the first swing guide rollers comes into contact with the optical fiber; and
imparting a twist to said optical fiber by said swinging.

14. An optical fiber manufacturing apparatus, comprising:
an optical fiber twist mechanism including a first swing guide roller having an arc concave surface, and
wherein said first swing guide roller is operable to swing around around a center axis, defined by both a center of the arc concave surface of the first swing guide roller on a plane including both revolving axis of said first swing guide roller and a contact point at which the first swing guide rollers comes into contact with the optical fiber.

15. An optical fiber manufacturing apparatus, comprising:
an optical fiber twist mechanism including a first swing guide roller having an arc convex surface and first swing guide roller and/or second swing guide roller swings around the center of said arc concave surface of said first swing guide roller in such a manner that said optical fiber is interposed between said arc concave surface of said firs swing roller guide and an arc convex surface of said second swing guide roller.
